(19) United States
(12) Patent Application Publication
(10) Pub. No.: US 2024/0070542 A1
(43) Pub. Date: Feb. 29, 2024

(54) FEDERATED LEARNING METHOD USING ARTIFICIAL INTELLIGENCE

(71) Applicant: Research & Business Foundation SUNGKYUNKWAN UNIVERSITY, Suwon-si (KR)

(72) Inventors: Jeehyong LEE, Seoul (KR); Yonghoon KANG, Suwon-si (KR)

(73) Assignee: Research & Business Foundation SUNGKYUNKWAN UNIVERSITY, Suwon-si (KR)

(21) Appl. No.: 18/446,859

(22) Filed: Aug. 9, 2023

(30) Foreign Application Priority Data
Aug. 26, 2022 (KR) 10-2022-0107470

(51) Int. Cl. G06N 20/00

(52) U.S. Cl. CPC G06N 20/00

(57) ABSTRACT

A federated learning method using artificial intelligence performed by a local client is disclosed. The federated learning method comprises receiving a model from a central server to store the model as a global model and a local model, learning the local model using internal data based on the global model, and transmitting the learned local model to the central server. The learning of the local model is performed by learning a discriminator model and a classifier using features of the global model and features of the local model in each batch of the internal data to generate the features of the local model through the learning of the local model so that the features of the local model are not discriminated as the discriminator model and to operate the classifier to classify a correct answer. Hence, divergence of the global model in federated learning can be suppressed.

### CROSS-REFERENCE TO RELATED APPLICATION(S)

This application claims the benefit under 35 USC § 119(a) of Korean Patent Application No. 10-2022-0107470 filed on Aug. 26, 2022, in the Korean Intellectual Property Office, the entire disclosures of which are incorporated herein by reference for all purposes.

### BACKGROUND

### 1. Field

The present disclosure relates to a federated learning method using artificial intelligence. More particularly, the present disclosure relates to a federated learning method using artificial intelligence for suppressing divergence of a global model in federated learning by learning a local model so that features of the local model are not distinguished from features of the global model.

### 2. Description of Related Art

As a distributed environment develops and the importance of data privacy is emphasized, federated learning is a method in which a central server generates a global model using model parameters learned from each client without direct data access for each client, unlike the existing artificial model that learns using data in a central server.

With the development of the distributed environment, it is possible to use data in various devices, and the use of these various data is often Not Independent and Identically Distributed (Non-IID), unlike conventional centralized data. The distribution of data described above has little influence on learning in a local client, but has a significant influence on global model generation in the central server, causing performance degradation. Ultimately, in the federated learning, it is necessary to solve the problem that data distribution becomes heterogeneous for each client due to data dispersion.

In the federated learning using artificial intelligence, a gap between the global model and the local model increases in a learning process due to Non-IID data of the local clients, causing the global model of the central server to diverge. A method to suppress this is required.

### SUMMARY

In order to solve problems of the related art described above, the present disclosure provides a federated learning method using artificial intelligence for suppressing divergence of a global model in federated learning by using a discriminator loss function used in adversarial learning to learn a local model so that features of the local model are not distinguished from features of the global model.

According to a first aspect of the present disclosure, there is provided a federated learning method using artificial intelligence performed by a local client, the federated learning method comprising receiving a model from a central server to store the model as a global model and a local model; learning the local model using internal data based on the global model; and transmitting the learned local model to the central server, wherein learning the local model comprises learning a discriminator model and a classifier using features of the global model and features of the local model in each batch of the internal data to generate the features of the local model through the learning of the local model so that the features of the local model are not discriminated as the discriminator model and to operate the classifier to classify a correct answer.

According to a second aspect of the present disclosure, there is provided a federated learning method using artificial intelligence performed by a central server, the federated learning method comprising transmitting a model to a local client, receiving a local model learned in the local client, and generating a new model based on the learned local model of the local client, wherein the learned local model is generated by storing the model received by the local client as a global model and a local model and learning the local model using internal data of the local client based on the global model, and wherein the learning of the local model comprises learning a discriminator model and a classifier using features of the global model and features of the local model in each batch of the internal data to generate the features of the local model through the learning of the local model so that the features of the local model are not discriminated as the discriminator model and to operate the classifier to classify a correct answer.

A federated learning method using artificial intelligence according to embodiments of the present disclosure provides the following effects.

The present disclosure can suppress divergence of a global model in federated learning by using a discriminator loss function used in adversarial learning to learn a local model so that features of the local model are not distinguished from features of the global model.

### BRIEF DESCRIPTION OF THE DRAWINGS

The accompanying drawings, which are included to provide a further understanding of the present disclosure and constitute a part of the detailed description, illustrate embodiments of the present disclosure and serve to explain technical features of the present disclosure together with the description.

FIG. 1 illustrates a framework for a federated learning method using artificial intelligence according to an embodiment of the present disclosure.

FIG. 2 illustrates a flowchart sequentially illustrating a federated learning method using artificial intelligence according to an embodiment of the present disclosure.

FIG. 3 is a table comparing image classification accuracy of a federated learning method using artificial intelligence according to an embodiment of the present disclosure and image classification accuracy of conventional federated learning methods in IID and Non-IID situations for CIFAR-10 dataset.

### DETAILED DESCRIPTION

Reference will now be made in detail to embodiments of the disclosure, examples of which are illustrated in the accompanying drawings. However, the following description is not intended to limit the present disclosure to a specific implementation. Detailed descriptions of known arts will be omitted if such may mislead the gist of the present disclosure.

Unless otherwise specified, all of the terms which are used herein, including the technical or scientific terms, have the same meanings as those that are generally understood by a person having ordinary skill in the art to which the present disclosure pertains. The terms defined in a generally used dictionary can be understood to have meanings identical to those used in the context of a related art, and are not to be construed to have ideal or excessively formal meanings unless they are obviously specified in the present disclosure.

Federated learning is an artificial intelligence model learning method, which uses only parameters of an artificial intelligence model learned in each local client to learn an artificial intelligence model of a central server, not a method of learning by using data in the central server.

Based on a distribution of data held by each local client, a data distribution environment is divided into an Independent Identically Distributed (IID) environment and a Not Independent and Identically Distributed (Non-IID) environment. The IID indicates that the distribution of data held by each local client is similar, in other words, an amount of data and labels are similarly distributed. The Non-IID indicates that the distribution of data held by each local client is different, in other words, an amount of data and labels are not similar and are differently distributed.

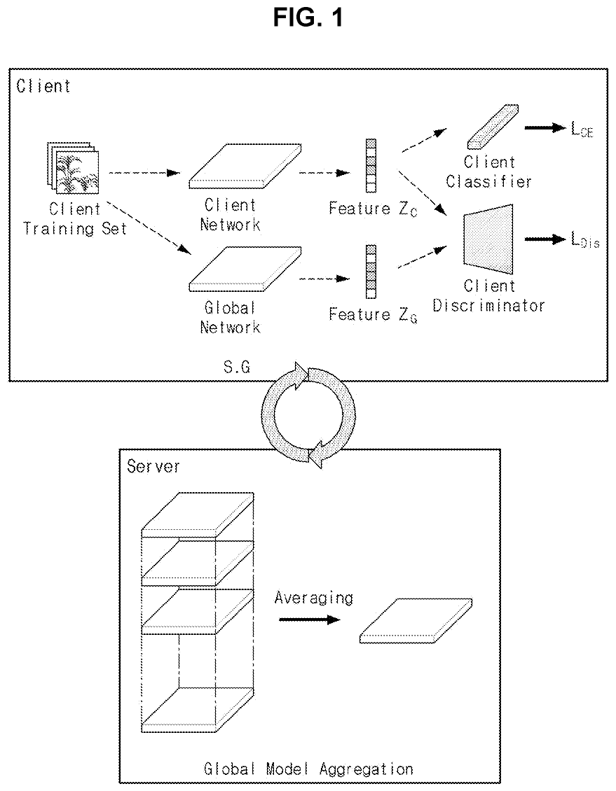

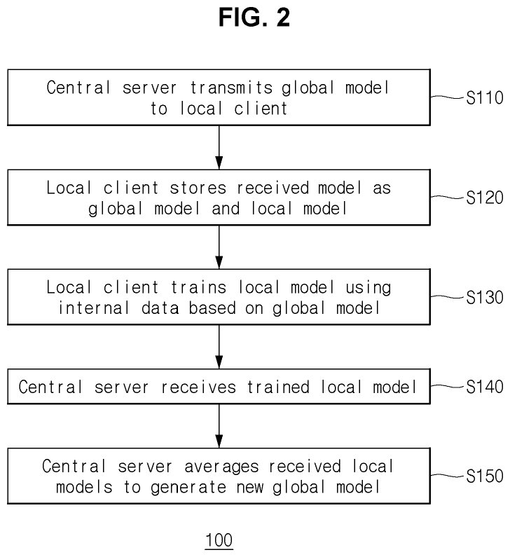

FIG. 1 illustrates a framework for a federated learning method using artificial intelligence according to an embodiment of the present disclosure, and FIG. 2 illustrates a flowchart sequentially illustrating the federated learning method.

The federated learning method using artificial intelligence according to the disclosed embodiment may be performed as follows with reference to FIG. 2.

In step S110, a central server transmits a global model to a local client.

In step S120, the local client receives the transmitted model and stores it as a global model and a local model.

In step S130, the local client uses the data inside the local client to learn the local model based on the global model.

In step S140, the central server receives the local model learned in the local client.

In step S150, the central server averages the local models received from each of the local clients to generate a new global model.

Hereinafter, the learning of the local model will be described in more detail with reference to FIG. 1.

A discriminator model included in the local client performs a function of discriminating features of the local model and the global model, and a classifier performs a function of classifying a correct answer through the features.

In the disclosed embodiment, in the learning of the local model, the discriminator model and the classifier are learned using features of the global model and features of the local model in each batch. Hence, the features of the local model are generated through the learning of the local model so that the features of the local model are not discriminated as the discriminator model, and the classifier operates to classify a correct answer. A discriminator function used in adversarial learning may be used so as to train the discriminator model so that the features of the local model are not distinguished from the features of the global model.

In the disclosed embodiment, the learned local model is transmitted from the local client to the central server, and the new global model is generated as in step S150. The process of steps S110 to S150 may be repeatedly performed in the central server and the local client as many times as set rounds.

Referring again to FIG. 1, in the disclosed embodiment, a loss function used for the learning in the local client is as shown in Equations 1 to 3 below.

$${L}_{CE} = - log ( \frac{exp ( {x}_{y} )}{{{\sum }^{j}}_{1} exp ( {x}_{j} )} ) \qquad [ Equation 1 ]$$

(where x_{y}: y-th dimension vector, xⱼ: j-th dimension vector, and j: the number of classes)

$$\text{?} = - \frac{1}{n} {{\sum }^{n}}_{i = 1} ( log D ( {z}_{global} ) + log ( 1 - D ( {z}_{local} ) ) \qquad [ Equation 2 ]$$

$$\text{?} \text{indicates text missing or illegible when filed}$$

(where z_{global}: global model feature vector, z_{local}: local model feature vector, D(z): predicted value determining the feature vector, and n: the number of data points)

L=L_{CE}+L_{Dis} [Equation 3]

(where L is a total loss function, L_{CE} is a loss function related to the classifier, and L_{Dis} is a loss function related to the discriminator model)

In the disclosed embodiment, the model may be updated so that the total loss function L decreases.

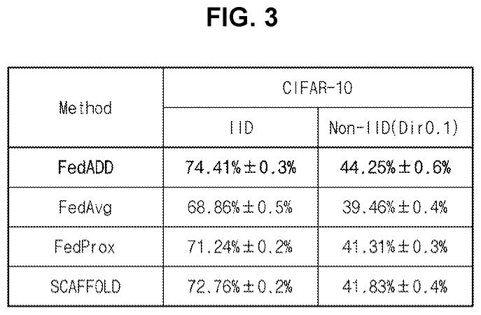

FIG. 3 is a table comparing image classification accuracy of the federated learning method using artificial intelligence according to the disclosed embodiment and image classification accuracy of conventional federated learning methods in IID and Non-IID situations for CIFAR-10 dataset.

In the disclosed embodiment, an experimental dataset used CIFAR-10, and a model used VGG-9 neural network. The number of clients used for learning was set to 10, the number of rounds was set to 100, and Non-IID was set to Dirichlet α=0.1.

Referring to FIG. 3, the federated learning method according to the disclosed embodiment corresponds to FedADD, and FedAvg, FedProx, and SCAFFOLD were used as the conventional federated learning method. It can be seen that the method of FedADD improved the classification performance by an average of about 7% in the IID situation and by an average of about 9% in the Non-IID situation, compared to the conventional federated learning methods.

So far, the federated learning method using artificial intelligence according to the present disclosure can suppress divergence of a global model in federated learning by using a discriminator loss function used in adversarial learning to learn a local model so that features of the local model are not distinguished from features of the global model.

Embodiments of the present disclosure can be implemented as computer-readable codes on a computer-readable recording medium. The computer-readable recording medium includes all types of recording devices in which data readable by a computer system is stored.

Examples of the computer-readable recording medium include a ROM, a RAM, a CD-ROM, a magnetic tape, a floppy disk, an optical data storage device, etc., and also include implementation in the form of a carrier wave (e.g., transmission over the Internet). Further, the computer-readable recording medium may be distributed to computer systems connected over a network, and computer-readable codes may be stored and executed in a distributed manner. Functional programs, codes, and code segments for implementing the present disclosure can be easily construed by programmers skilled in the art to which the present disclosure pertains.

Since various modified examples can be made by a configuration and a method described and exemplified in the present disclosure without departing from the scope of the present disclosure, all matters included in the detailed description or illustrated in the accompanying drawings are illustrative and do not limit the present disclosure. Accordingly, the scope of the present disclosure is not limited by the exemplary embodiment, but should be defined only according to the following claims and equivalents thereto.

What is claimed is:

1. A federated learning method using artificial intelligence performed by a local client, the federated learning method comprising:
receiving a model from a central server to store the model as a global model and a local model;
learning the local model using internal data based on the global model; and
transmitting the learned local model to the central server,
wherein learning the local model comprises:
learning a discriminator model and a classifier using features of the global model and features of the local model in each batch of the internal data to generate the features of the local model through the learning of the local model so that the features of the local model are not discriminated as the discriminator model and to operate the classifier to classify a correct answer.

2. The federated learning method of claim 1, wherein a loss function (T E) of the following Equation is used to learn the classifier:
$${L}_{CE} = - log ( \frac{exp ( {x}_{y} )}{{{\sum }^{j}}_{1} exp ( {x}_{j} )} )$$
(where x_{y}: y-th dimension vector, xⱼ: j-th dimension vector, and j: the number of classes).

3. The federated learning method of claim 2, wherein a loss function (L_{Dis}) of the following Equation is used to learn the discriminator model:
$$\text{?} = - \frac{1}{n} {{\sum }^{n}}_{i = 1} ( log D ( {z}_{global} ) + log ( 1 - D ( {z}_{local} ) )$$
$$\text{?} \text{indicates text missing or illegible when filed}$$
(where z_{global}: global model feature vector, z_{local}: local model feature vector, D(z): predicted value determining the feature vector, and n: the number of data points).

4. The federated learning method of claim 3, wherein a total loss function is calculated as a sum of the loss function used for the learning of the classifier and the loss function used for the learning of the discriminator model, and
wherein the learning of the local model is performed so that the calculated total loss function decreases.

5. The federated learning method of claim 1, further comprising:
after transmitting the learned local model to the central server, repeatedly performing steps of receiving a new model from the central server to store the new model, learning the local model, and transmitting the learned local model to the central server,
wherein the new model is a model newly generated by averaging the learned local model of the local client and learned local models of other local clients in the central server.

6. The federated learning method of claim 1, wherein the local client operates under a non-independent identically distributed environment.

7. A federated learning method using artificial intelligence performed by a central server, the federated learning method comprising:
transmitting a model to a local client;
receiving a local model learned in the local client; and
generating a new model based on the learned local model of the local client,
wherein the learned local model is generated by storing the model received by the local client as a global model and a local model and learning the local model using internal data of the local client based on the global model, and
wherein the learning of the local model comprises learning a discriminator model and a classifier using features of the global model and features of the local model in each batch of the internal data to generate the features of the local model through the learning of the local model so that the features of the local model are not discriminated as the discriminator model and to operate the classifier to classify a correct answer.

8. The federated learning method of claim 7, wherein a loss function (L_{CE}) of the following Equation is used to learn the classifier:
$${L}_{CE} = - log ( \frac{exp ( {x}_{y} )}{{{\sum }^{j}}_{1} exp ( {x}_{j} )} )$$
(where x_{y}: y-th dimension vector, xⱼ: j-th dimension vector, and j: the number of classes).

9. The federated learning method of claim 8, wherein a loss function (L_{Dis}) of the following Equation is used to learn the discriminator model:
$$\text{?} = - \frac{1}{n} {{\sum }^{n}}_{i = 1} ( log D ( {z}_{global} ) + log ( 1 - D ( {z}_{local} ) )$$
$$\text{?} \text{indicates text missing or illegible when filed}$$
(where z_{global}: global model feature vector, z_{local}: local model feature vector, D(z): predicted value determining the feature vector, and n: the number of data points).

10. The federated learning method of claim 9, wherein a total loss function is calculated as a sum of the loss function used for the learning of the classifier and the loss function used for the learning of the discriminator model, and
wherein the learning of the local model is performed so that the calculated total loss function decreases.

11. The federated learning method of claim 7, further comprising:
after generating the new model, repeatedly performing steps of transmitting the new model to the local client, receiving the learned local model, and generating the new model,
wherein the new model is a model newly generated by averaging the learned local model of the local client and learned local models of other local clients in the central server.

12. The federated learning method of claim 7, wherein the local client operates under a non-independent identically distributed environment.
